(19) United States
(12) Patent Application Publication
(10) Pub. No.: US 2026/0138933 A1
(43) Pub. Date: May 21, 2026

(54) COMPOSITION AND METHODS FOR INCREASING SURFACE HARDNESS OF CONCRETE

(71) Applicant: Curecrete Distribution, Inc., Springville, UT (US)

(72) Inventors: James Varnell, City of Kawartha Lakes (CA); Roy Benjamin Bowman, II, Tulsa, OK (US)

(73) Assignee: Curecrete Distribution, Inc., Springville, UT (US)

(21) Appl. No.: 19/326,533

(22) Filed: Sep. 11, 2025

Related U.S. Application Data
(60) Provisional application No. 63/694,093, filed on Sep. 12, 2024.

(51) Int. Cl. C04B 41/52; C04B 41/45; C04B 41/46; C04B 41/50; C04B 41/68; C04B 41/70

(52) U.S. Cl. CPC C04B 41/52; C04B 41/4535; C04B 41/463; C04B 41/5024; C04B 41/5072; C04B 41/68; C04B 41/70

(57) ABSTRACT

The present disclosure relates to a composition that increases the hardness of concrete surface and methods for producing and using the same. In particular, the composition of the disclosure is a solution comprising a solvent and calcium compound, wherein the solvent comprises a polyhydroxy compound, water, and optionally ethanol.

### CROSS-REFERENCE TO RELATED APPLICATIONS

This application claims the priority benefit of U.S. Provisional Application No. 63/694,093, filed Sep. 12, 2025, which is incorporated herein by reference in its entirety.

### FIELD OF THE INVENTION

The present disclosure relates to a composition that increases the surface hardness of concrete and methods for producing and using the same.

### BACKGROUND OF THE INVENTION

Concrete is the world's most widely used construction material in the world. Its presence is ubiquitous in modern buildings, roads, pedestrian walkways, bridges, etc.

Concrete is a composite made from several materials, one of which is cement. Cement in turn is made from limestone, a sedimentary rock. To make cement, limestone is quarried, mixed with a silica, typically aluminosilicate, source, such as industrial byproducts slag or fly ash, and sintered at a high temperature to produce an intermediary product known as clinker. Clinker occurs as lumps or nodules, usually 3 millimeters to 25 millimeters in diameter. The Portland clinker essentially consists of four minerals: two calcium silicates, alite (Ca₃SiO₅) and belite (Ca₂SiO₄), along with tricalcium aluminate (Ca₃Al₂O₆) and calcium aluminoferrite (Ca₂(Al,Fe)₂O). Upon addition of water, clinker minerals form different types of hydrates and “set” (harden) as the hydrated cement paste becomes concrete. The calcium silicate hydrates (CSH) represent the main glue or adhesive components of the concrete. After initial setting the concrete continues to harden and to develop its mechanical strength. In general, the first 28 days are critical for the hardening. The concrete does not dry but sets and hardens. The cement is essentially a hydraulic binder whose hydration requires water, which is essential to its hardening. Water losses must be avoided at the young age (e.g., first 28 days) to avoid the development of cracks. Traditional methods for preventing loss of water can include covering the product with wet sheeting. For larger projects, the surface may be sprayed with a solution of curing compound that leaves a water-impermeable coating.

Unfortunately, cement manufacturing has been targeted as a major contributor to global warming. Moreover, U.S. cement is believed to be more emissions intensive than cement produced in other countries. This is in part because the U.S. is lagging in the adoption of low-carbon “blended cements,” a readily available decarbonization solution used in many other countries. The main source of emissions in cement comes from production of clinker, an intermediary binding material in cement. Clinker is created using an emissions-intensive process that heats up limestone and other materials. In total, it is believed that around 70% of carbon dioxide emissions from making cement results from the production of clinker. U.S. cement produces more emissions than cement made in many other countries because it contains more clinker. The average clinker-to-cement ratio in the U.S. is about 0.88 (i.e., 880 kilograms clinker per ton of cement), while the world average is 0.76. In the EU, India, and China, the ratio is between 0.64 and 0.76. In fact, a study in 2019 estimated the emissions intensity of cement production in the U.S. was around 20% higher than that of other major cement-producing parts of the world.

To reduce carbon dioxide emission, cement producers have resorted to replacing some of the clinker with low-carbon materials known as supplementary cementitious materials (SCMs). SCMs include waste byproducts such as slag and fly ash or other natural materials such as clay. This clinker substitution is typically done while making cement at the plant to produce “blended cements.” Use of SCMs reduces the total calcium content of concrete resulting in concrete having a relatively lower surface hardness. Concrete with reduced surface hardness can be easily scratched, damaged, or cracked, thereby requiring constant repair. Thus, lower surface hardness of concrete results in increased cost and time in maintaining the concrete surface.

Accordingly, there is a need for a method of increasing the hardness of SCM concrete mixes.

### SUMMARY OF THE INVENTION

Some aspects of the disclosure provide a composition that can be used to increase the hardness of concrete surface, thereby significantly reducing the likelihood of concrete surface damage, deformity, and/or irregularity, etc. due to, for example, chipping, cracking, scratching, or other surface defects, etc.

In particular, some aspects of the disclosure provide a solution comprising a solvent and calcium hydroxide. The solvent typically comprises a polyhydroxy compound and water. In some embodiments, the amount of water in the solvent is about 75% vol/vol or less.

In some embodiments, said polyhydroxy compound comprises glycerine, a sugar alcohol, or a combination thereof. In some instances, said sugar alcohol comprises sorbitol, ethylene glycol, glycerol, erythritol, threitol, arabitol, xylitol, ribitol, mannitol, galactitol, fucitol, iditol, inositol, volemitol, isomalt, maltitol, lactitol, maltotriitol, maltotetraitol, polyglycitol, or a combination thereof.

Yet in other embodiments, the amount of calcium hydroxide in the solution ranges from about 0.1% wt/vol to about 5% wt/vol.

Yet other aspects of the disclosure provide a method for treating a concrete surface to increase its hardness. Generally, the method includes:
applying a surface hardening composition to a concrete surface which is no wetter than surface-saturated-dry (SSD) to produce a first treated surface, wherein said surface hardening composition comprise:
   a solution comprising a solvent and calcium hydroxide, wherein said solvent comprises a polyhydroxy compound and water; and
applying a silicate densifier to the first treated surface to produce a hardened concrete surface.

In some embodiments, excess surface hardening composition is removed from the concrete surface before applying the silicate densifier, for example, by washing the concrete surface with water.

In some embodiments, the method also includes agitating the surface hardening composition that is applied to said concrete surface for at least about 30 min to about 120 min prior to applying said silicate densifier. In some instances, the method also includes the step of washing the concrete surface with water after agitating the surface hardening composition.

Still in other embodiments, the method further includes preparing the concrete surface prior to applying said surface hardening composition. Typically, the step of preparing the concrete surface comprises:
cleaning the concrete surface with a concrete surface cleaner;
removing free-standing water from the concrete surface; and
maintaining a surface which is no wetter than SSD before the application of said hardening composition.

Yet in other embodiments, the surface hardening composition is applied to the concrete surface at a rate of about 200 to about 600 SqFt per gallon per hour.

In further embodiments, the method also includes maintaining wet and agitated state of the first treated surface prior to said step of applying the silicate densifier.

In other embodiments, the silicate densifier is applied at a rate of about 150 to about 600 SqFt per gallon per hour.

In some embodiments, said surface hardening composition is applied to an uncured surface of concrete. Yet in other embodiments, said surface hardening composition is applied to a cured surface of concrete.

Yet still in other embodiments, said hardened concrete surface has at least about 3 Mohs scale hardness increase compared to an untreated concrete surface.

Still other aspects of the disclosure provide a concrete surface hardening solution comprising calcium hydroxide dissolved in a solvent comprising a polyhydroxy compound. In some embodiments, the amount of calcium hydroxide ranges from about 0.1% wt/vol to about 2% wt/vol.

Still further aspects of the disclosure provide a method for increasing a surface hardness of a concrete. The method includes:
preparing a concrete surface for hardening;
applying a concrete surface hardening solution to the prepared concrete surface that is no wetter than surface-saturated-dry (SSD) to produce a first treated surface; and
applying a silicate densifier to the first treated surface to produce a concrete having an increased hardness.

In some embodiments, said step of preparing the concrete surface comprises:
cleaning the concrete surface with a concrete surface cleaner;
optionally removing any surfactant, excess water, or a combination thereof from the concrete surface; and maintaining a SSD condition during application of said hardening composition.

Still in other embodiments, said concrete surface hardening solution is applied to the prepared concrete surface at a rate of about 200 to about 600 SqFt per gallon and allowed to dwell on the floor for from about 30 min to about 120 min, typically from about 45 min to about 90 min, and often for about one hour. Application must remain wet during dwell time by applying more solution, more water, or both.

Yet in other embodiments, the method also includes the steps of maintaining wet and agitated state of the first treated surface prior to said step of applying the silicate densifier.

### DETAILED DESCRIPTION OF THE INVENTION

The terms “comprise(s),” “include(s),” “having,” “has,” “can,” “contain(s),” and variants thereof, as used herein, are intended to be open-ended transitional phrases, terms, or words that do not preclude the possibility of additional steps or components or ingredients. The singular forms “a,” “an” and “the” include plural references unless the context clearly dictates otherwise. The present disclosure also contemplates other embodiments “comprising,” “consisting of” and “consisting essentially of,” the embodiments or elements presented herein, whether explicitly set forth or not. Accordingly, the transitional phrases “consisting of” and “consisting essentially of” may be interpreted to be subsets of the open-ended transitional phrases, such as “comprising” and “including,” such that any use of an open-ended phrase to introduce a recitation of a series of elements, limitations, components, ingredients, materials, or steps should be interpreted to also disclose recitation of the series of elements, limitations, components, ingredients, materials, or steps using the closed terms “consisting of” and “consisting essentially of.” For example, the recitation of a composition “comprising” components A, B, and C should be interpreted as also disclosing a composition “consisting of” components A, B, and C as well as a composition “consisting essentially of” components A, B, and C.

When used in the claims, whether as filed or added per amendment, the transition term “consisting of” excludes any element, step, or ingredient not specified in the claims. The transition term “consisting essentially of” limits the scope of a claim to the specified materials or steps and those that do not materially affect the basic and novel characteristic(s). Embodiments of the invention so claimed are inherently or expressly described and enabled herein.

The term “about” or “approximately” as used herein refers to being within an acceptable error range for the particular value as determined by one of ordinary skill in the art, which will depend in part on how the value is measured or determined, i.e., the limitations of the measurement system, i.e., the degree of precision required for a particular purpose. For example, the term “about” can mean within 1 or more than 1 standard deviation, per the practice in the art. Alternatively, the term “about” when referring to a numerical value can mean±20%, typically ±10%, often ±5% and more often ±1% of the numerical value. In general, however, where particular values are described in the application and claims, unless otherwise stated, the term “about” means within an acceptable error range for the particular value.

Unless stated otherwise, the term “hardness” refers to Mohs scale of hardness.

Cement is one of the most widely used materials and a critical component of roads, bridges, and buildings. Cement can be used to produce cement-based structures. However, cement is often mixed with water, sand, and aggregates or stones to produce concrete, which is then used for modern structures, such as buildings, bridges, pedestrian walkways, roads, etc. What makes concrete so strong is the chemical reaction that occurs when cement and water mix—a process known as hydration. During hydration, cement dissolves into the calcium and recombines with water and silica to form calcium silica hydrates. Calcium silica hydrates, or CSH, are the key to cement's strength and hardness. As they form, they combine, developing tight bonds that lend strength and hardness to the material.

Cement manufacturing is also a major contributor to carbon dioxide (CO₂) emissions through both energy use and calcination reactions. To help meet net zero climate goals, cement industry is developing a variety of techniques to reduce the net amount of CO₂ emitted from cement manufacturing. While there are many approaches for reducing CO₂ emission, such as, taking advantage of carbonation, i.e., the uptake of CO₂, by curing concrete under a CO₂ atmosphere or injecting CO₂ during the mixing process.

One particular method often used for reducing CO₂ emission in cement production process is to change the composition of the cement. Typically, this method involves replacing some of the clinker with low-carbon materials known as supplementary cementitious materials (SCMs). The U.S. Department of Energy (DOE) considers clinker substitution to be the most powerful lever to decarbonize cement through 2030 and estimates that deploying blended cements would reduce U.S. cement emissions by 20% to 25%. See, for example, websites liftoff.energy.gov/industrial-decarbonization/low-carbon-cement/and energy.gov/articles/doe-releases-new-reports-pathways-commercial-liftoff-accelerate-clean-energy-technologies. In order to achieve net zero emission standard, U.S. government and industry are both ramping up action and investment to decarbonize the cement sector. In fact, the Portland Cement Association (PCA), which represents many U.S. cement producers, has set a target of reducing its clinker-to-cement ratio to 0.75 by 2050. And the Global Cement and Concrete Association, which represents 40% of the world's cement producers and 85% of U.S. cement producers, aims to decrease the global average clinker ratio to 0.58 by 2050.

Unfortunately, some of the methods for reducing CO₂ emission has resulted in concrete surfaces having a less than desired hardness. In some cases, concrete surfaces with reduced amount of clinker have shown to be easily scratched, cracked, and/or damaged when pressure is applied. In particular, with the introduction of lower carbon cements formulations, there is a recognized reduction in calcium hydroxide producing potential, specifically Portland lime cements (PLC) and/or high concentrations of supplementary cementitious materials (SCM's) such as of fly ash, slag, or silica fume. As a result, PLC and other SCM concrete exhibits a relatively softer surface with increased pore structure compared to ordinary Portland cement (OPC). For floor slabs the softer surface is of particular importance considering the wear damage that the surface will be subject to. However, softer concrete for other concrete surfaces is also of great concern.

The present inventors have discovered that this reduction in concrete surface hardness can be modified by using the compositions and methods disclosed herein. What makes concrete so strong is the chemical reaction that occurs when cement and water is mixed. Without being bound by any theory, it is believed that when cement is mixed with water calcium hydroxide in limestone dissolves in water and recombines with water and silica to form calcium silica hydrates. It is this formation of calcium silica hydrates inter alia that is believed to render concrete its strength and surface hardness. Unfortunately, by reducing the amount of clinker in cement in order to achieve reduced carbon dioxide emission results in a lower amount of calcium compounds present in cement, thereby resulting in a reduced amount of calcium silica hydrates formation and hence reduction in surface hardness.

Calcium silica hydrates, or CSH, are the key to cement's solidity, strength, and surface hardness. As CSH form, they combine, developing tight bonds that provide strength to the material. One of the consequences of CSH formation is that concrete has a porous structure. It is believed that tiny pores developed within the spaces between the CSH bonds range on the scale of about 3 nanometers. These are sometimes referred to or known as gel pores. On top of this, any water that hasn't reacted to form CSH during the hydration process remains in the cement, creating another set of larger pores, called capillary pores. In one particular study showed cement paste is so porous that 96 percent of its pores are connected. Despite this porosity, cement possesses excellent strength and binding properties. However, by decreasing this porosity, one can create a denser and even stronger final product.

The present inventor has found that by introducing additional CSH formation within the surface of concrete, more particularly within the surface pores of concrete results in increased surface hardness, thereby significantly increasing abrasion resistance of the treated concrete surface. Accordingly, some aspects of the disclosure provide a composition that can be used to introduce additional calcium hydroxides within the surface and/or pores of concrete. Without being bound by any theory, it is believed that compositions and methods disclosed herein can be used to introduce additional CSH formation within at least about 1 mm, typically at least about 2 mm, often at least about 3 mm, more often at least about 4 mm, still more often at least about 5 mm, and most often at least about 6 mm of the pores from the surface of concrete. However, it should be appreciated that the scope of the invention is not limited to these particular surface penetration values. In some embodiments, the scope of the invention can be determined by the amount of hardness increase exhibited by the concrete surface. Typically, the compositions and methods of the disclosure result in hardness increase of at least 2, typically at least 3, often at least 4, and most often at least 5 on the Mohs hardness test.

It is believed that compositions and methods disclosed herein provide reactivity sites of calcium hydroxide for silicate based densifying agents, such as sodium silicates to create additional CSH and reduce the size and amount of pores present on the surface of the concrete. Silicate and siliconate based densifiers have been used successfully for over 75 years to harden and dust proof concrete, by reacting with the residual calcium hydroxide that is present during the cement hydration process. This dust proofing and hardening process dramatically increases the service life of the finished concrete by filling the pores of the concrete with CSH crystal growth in the pore structure. Again without being bound by any theory, this process is believed to be disrupted with the new low carbon cements, since there is less reactive material in the concrete for the densifiers to form CSH.

Compositions and methods of the disclosure reduce the amount and/or the size of capillary pores in part by increasing the CSH formation within the pores, reducing the water-to-cement ratio, and/or reducing the water that remains after hydration. This reduction in the amount and/or the size of pores increases the strength and/or the hardness of concrete surface.

In one particular aspect of the disclosure, a solution is provided that includes a solvent and a calcium compound. Exemplary calcium compounds that can be used in the present disclosure include, but are not limited to, calcium hydroxide, calcium salts (such as calcium carbonate, calcium halides, e.g., calcium chloride, calcium sulfate, calcium sulfite, etc.) as well as other calcium compounds that results in formation of CSH when combined or mixed with a silicate source or silicate densifier. In some embodiments, calcium compound includes calcium halides, calcium carbonate, calcium bicarbonate, calcium hydroxide, or a combination thereof. In one particular embodiment, the calcium compound is calcium hydroxide. It should be appreciated that the scope of disclosure is not limited to these particular calcium compounds. In general, any calcium compound known to one skilled in chemistry that can form CSH when mixed, combined, or reacted with a silicate densifier or silicate source can be used in the present disclosure. For example, calcium chloride can be used in conjunction with addition of a hydroxide source, such hydroxide sources are well known to one skilled in chemistry. Exemplary hydroxide sources include, but are not limited to alkaline hydroxides, such as sodium hydroxide, lithium hydroxide, etc., and alkaline earth hydroxides, such as magnesium hydroxide, calcium hydroxide, etc. In general, any hydroxides that can generate calcium hydroxide from calcium salt or other calcium compounds can be used in the present disclosure.

The amount of calcium compound present in the solution can range from about 0.1% wt/vol to about 5% wt/vol, typically from about 0.1% wt/vol to about 2.5% wt/vol, often from about 0.1% wt/vol to about 2% wt/vol, still more often from about 0.2% wt/vol to about 1.5% wt/vol, and most often from about 0.5% wt/vol to about 1.5% wt/vol.

Surprisingly and unexpectedly, the present inventors have discovered that depending on the degree of carbonation or amount of carbon present in the concrete, the amount of calcium hydroxide may be adjusted. Carbonation of concrete is a continuous process in which the metal hydroxide (typically calcium hydroxide) that is present in the concrete reacts with carbon dioxide in the atmosphere to produce a calcium carbonate and water as illustrated in the following reaction: Ca(OH)₂+CO₂→CaCO₃+H₂O. The carbonation of concrete starts with the concrete surface and gradually moves towards the inner area of the concrete. Because the carbonation of concrete is diffusion dependent, it is a slow and continuous process. When the carbonation reaches the reinforcement bar (i.e., rebar), it could start the corrosion of rebar steel leading to weakening of concrete strength.

One can determine the depth of carbonation using a variety of techniques known to one of ordinary skill in the art. One method is using a solution of phenolphthalein and spraying the exposed concrete. If the color of the concrete change to pink, that area of the concrete is not carbonated. The area that did not change color with the application of phenolphthalein is carbonated. Another method is to use an infrared (IR) spectrum analysis. The relative intensity of IR absorption by CO₂ can readily allow one skilled in the art to determine the level or amount of concrete carbonation. Other methods for determining the degree of carbonation include empirical methods that allows one to readily calculate the depth of the carbonation of concrete. Any of the methods known to one of ordinary skill can be used to determine the degree of concrete carbonation.

As a general rule of thumb, a less amount of calcium hydroxide is need in a composition of the disclosure for concrete that has undergone less carbonation. Accordingly, in one particular embodiment, for use in a low-carbon concrete that has not undergone a significant carbonation (i.e., less than about 7 mm in depth of carbonation, typically less than about 6 mm in depth, often less than about 5 mm in depth, more often less than about 3 mm in depth, and most often less than about 1 mm in depth), a composition comprises from about 0.5% to about 1.2%, typically from about 0.6% to about 1.0%, often from about 0.7% to about 0.9%, and most often about 0.8% of calcium oxide.

For concrete surfaces that have experienced carbonation, the composition of the disclosure used has a relatively high amount of calcium hydroxide. For example, in one particular embodiment of the disclosure, for use in concrete surfaces that has experienced a significant carbonation (i.e., at least about 3 mm in depth of carbonation, typically at least about 5 mm in depth, often at least about 7 mm in depth, more often at least about 9 mm in depth, and most often at least about 12 mm in depth) the amount of calcium hydroxide in the composition ranges from about 0.5% to about 2%, typically from about 0.75% to about 1.75%, often from about 0.8% to about 1.5%, more often from about 1% to about 1.4%, still more often from about 1.1% to about 1.3%, and most often about 1.28%.

The solvent includes a polyhydroxy compound and water. Polyhydroxy compounds can be any organic compound having two or more hydroxide or hydroxyl groups. The terms “polyhydroxy compound” and “polyhydroxide compound” and “polyhydroxyl compound” are used interchangeably herein and refer to any organic compound having two or more hydroxyl (i.e., —OH) groups. Exemplary polyhydroxy compounds that can be used as a solvent in the disclosure include, but are not limited to, glycerine, a sugar alcohol, or a combination thereof. Exemplary sugar alcohols include, but are not limited to, sorbitol, ethylene glycol, glycerol, erythritol, threitol, arabitol, xylitol, ribitol, mannitol, galactitol, fucitol, iditol, inositol, volemitol, isomalt, maltitol, lactitol, maltotriitol, maltotetraitol, polyglycitol, or a combination thereof. In one particular embodiment, the solvent includes glycerine, sorbitol, or a combination thereof.

The amount of polyhydroxy compound present in the solvent ranges from about 5% v/v to about 90% v/v, typically from about 10% v/v to about 75% v/v, often from about 20% v/v to about 50% v/v, more often from about 25% v/v to about 40% v/v, still more often from about 30% v/v to about 40% v/v. In some embodiments, the solution of the disclosure includes at least about 10% v/v, typically at least about 15% v/v, often at least about 20% v/v, still at least about 25% v/v, and most often at least about 30% v/v of polyhydroxy compound in the solution. In one particular embodiment, the amount of polyhydroxy compound in the solvent is at least about 20% v/v of the solution.

The solvent also includes water. Water can readily dissolve many calcium compounds and aids in formation of a solution. The amount of water present in the composition of the disclosure can range from about 10% v/v to about 90% v/v, from about 50% v/v to about 85% v/v, typically from about 50% v/v to about 80% v/v, often from about 55% v/v to about 80% v/v, still more often from about 60% v/v to about 80% v/v, and most often from about 65% v/v to about 75% v/v of the solution. In some embodiments, the amount of water present is from about 65% v/v to about 85% v/v of the solution. Yet in other embodiments, the solvent has less than about 80% vol/vol (v/v) of water, often less than about 75% v/v, more often less than about 70% v/v, still more often less than about 65% v/v, and most often less than about 60% v/v of water.

Compositions of the disclosure are suitable for newly placed concrete that has achieved hardness enough for wheeled traffic and has hydrated enough to apply densification agents. In general, concrete substrate must be sound and possess a minimum compressive strength of at least about 17 Mpa, typically at least about 20 Mpa, often at least about 25 Mpa, more often at least about 27.5 Mpa, and most often at least about 30 Mpa. Typically, compositions of the disclosure can be used on concrete surfaces that have been set for about 28 days or less, typically about 25 days or less, often about 20 days or less, more often about 10 days or less, and most often about 1 day or less. However, it should be appreciated that the scope of the disclosure is not limited to concretes having set for these particular amounts of days. In fact, compositions and methods of the disclosure can be used on any concrete as long as the surface is absorptive or can be treated to be made absorptive.

In using the compositions of the disclosure, the substrate is cleaned with a quality concrete cleaner that leaves no significant residual surfactants. Concrete cleaners are well known to one skilled in the art and commercially available. Any available concrete cleaners can be used in methods of the disclosure as long as one ensures removal of substantially all, (e.g., at least 98% or more, typically, at least 99% or more, often at least 99.5% or more, more often at least 99.9% or more, and most often at least 99.99% or more) of the surfactant from the concrete surface. For example, by washing the concrete surface with water after use of concrete surface cleaner. It should be appreciated that use of concrete surface is not necessary on a freshly laid concrete, e.g., concretes that have been poured or formed within about 28 days or less, typically about 25 days or less, often about 20 days or less, more often about 10 days or less, and most often about 1 day or less. In a freshly laid concrete, a simply washing with water will be sufficient for its surface preparation. Proper surface preparation is important in the success of increasing the surface hardness of concrete using the methods and compositions of the disclosure.

The concrete surface must be clean, dry, and free of substantially all contaminants such as dirt, oil, grease, coatings, and surface treatments, etc. Once the concrete surface has been prepared, a maximum wettness of surface saturated dry (SSD) is maintained. SSD is well known to one skilled in the art and can be determined using any one of the moisture measurement methods known to one skilled in the art, such as using an electronic moisture meter. See (i) ASTM F2659-Standard Guide for Preliminary Evaluation of Comparative Moisture Condition of Concrete, Gypsum Cement and Other Floor Slabs and Screeds Using a Non-Destructive Electronic Moisture Meter; (ii) ASTM F2170-Standard Test Method for Determining Relative Humidity in Concrete Floor Slabs Using In-situ Probes; (iii) ASTM F2420-Determining Relative Humidity on the Surface of Concrete Floor Slabs Using Relative Humidity Probe Measurement and Insulated Hood; and (iv) ASTM F1869-Standard Test Method for Measuring Moisture Vapor Emission Rate of Concrete Subfloors Using Anhydrous Calcium Chloride. In general, all that is required is that concrete surface be wet but there is no observable standing water on the surface or be at SSD. While the term “SSD” is well known to one skilled in the art, quantitatively and for the present disclosure, it refers to having about 20 cubic centimeter (cc) or less, typically about 15 cc or less, often about 10 cc or less, more often about 5 cc or less, still more often about 2 cc or less, and most often about 1 cc or less of standing water per square meter of concrete surface. In some embodiments, the term “SSD” refers to having no observable standing water. The term “standing water” refers to a droplet or a puddle of water having an average diameter size of about 0.5 cm or more, typically about 1 cm or more, often about 1.5 cm or more, and most often about 2 cm or more.

Typically, in using compositions of the disclosure, once the concrete surface is prepared, SSD is maintained to ensure there is a sufficient water content to form CSH. It should be appreciated, however, any excess water on the surface of concrete should be avoided. Thus, while there can be residual moisture remaining in the surface, there should be no “free-standing” or observable water on the surface. In generally, substantially all of the concrete surface area is absent of any observable standing or free water. The term “standing” or “free” water refers to water that can be readily removed with mere contact (i.e., without any external pressure being applied) with an absorbent, e.g., cloth towel or paper towel.

In some embodiments, the concrete surface is prepared to be only slightly damp with no observable free water remaining, similar to having the surface dried with a towel. Typically, SSD condition means the concrete pores are saturated with water to a depth of at least about 0.25 mm, typically at least about 0.50 mm, often at least about 0.75 mm, more often at least 1 mm, and most often at least about 1.5 mm. Alternatively, SSD condition refers to having appearance of concrete being wet without having any standing water. Having the concrete surface at or near SSD when applying the composition of the disclosure ensures proper concrete surface hardening.

Once the surface is prepared, a composition of the disclosure is applied to its surface, and the composition is allowed to remain on the surface of concrete undisturbed for a period of time. While the dwelling time, i.e., a period of time left undisturbed, can vary depending on a variety of factors, such as, but not limited to, the concentration of the composition, temperature of the concrete surface, absence or presence or speed of air movement, nature of the composition, etc., typical dwelling time is at least about 30 min, typically, at least about 45 min, often at least about 60 min, more often at least about 90 min, and most often at least about 120 min. The rate and amount of application of the composition of the disclosure to the concrete surface also depends on many factors such as porosity of concrete surface, ambient temperature, the surface area, humidity of air, etc. In some particular embodiments, the amount of composition of the disclosure applied to the surface ranges from about 50 to about 500 ft²/gallon (about 1.23 to about 12.3 m²/L), typically from about 75 to about 400 ft²/gallon (about 1.84 to about 24.5 m²/L), and often from about 100 to about 300 ft²/gallon (about 2.45 to about 7.36 m²/L). The rate of application should be fast enough to prevent drying of applied composition prior to complete treatment of the concrete surface. Generally, the entire concrete surface is treated at a rate of from about 0.5 L/m² to about 20 L/m² of concrete surface, typically from about 1 to about 15 L/m², and often from about 2 to 10 L/m² of concrete surface. It should be appreciated, however, the scope of disclosure is not limited to these particular ranges as the application rate will depend on variety of factors discussed above. Accordingly, the application rate is provided solely for the purpose of illustrating the practice of the present disclosure and does not constitute limitations on the scope of the present disclosure.

Once the composition of the disclosure is applied to a concrete surface, it should be kept on the surface for at least about 30 min, typically at least about 45 min, often at least about 60 min, more often at least about 90 min, and most often at least about 120 min. In some embodiments, the composition of the disclosure that has been applied to the concrete surface is agitated frequently (e.g., once about every 10 min, typically about every 15 min, often about every 20 min, and more often about every 30 min) with mechanical means, e.g., brooms or auto scrubbers. If the surface begins to dry, a light application of water or additional composition of the disclosure may be necessary. The goal is to keep the concrete surface wet and agitated with the composition of the disclosure for at least about 30 min, often at least about 45 min, more often at least about 60 min, and most often at least about 150 min.

After the concrete surface has been treated and left standing for a desired period, substantially all residual water and composition of the disclosure are removed from the surface. The concrete surface is then optionally scrubbed with water. Removal of any calcium hydroxide or other calcium compound from the concrete pores should be minimized or avoided all together. After cleaning or removal of residual water and the composition of the disclosure, the concrete surface is treated with a silicate densifier. Any silicate densifier known to one skilled in the art can be used in methods of the disclosure. Exemplary silicate densifiers that can be used in the present disclosure include, but are not limited to, reactive silicates (such as, but not limited to, sodium silicate, lithium silicate, potassium silicate, colloidal silica, etc.) silanes (e.g., aminosilanes, alkoxysilanes, and other organosilanes), siloxanes, as well as other silicate densifiers known to one skilled in the art. In general, any silicon containing compound that can react with calcium hydroxide to form CSH can be used in the present disclosure. The silicate densifier may be applied at a rate similar to the rate of application of the composition of the disclosure, or as provided by the silicate densifier manufacture's instruction. Typically, application rate of the silicate densifier is similar to the application rate of the composition of the disclosure. However, it should be appreciated that the rate of silicate application can vary depending on various factors including, but not limited to, site conditions, the product of concrete surface being applied (e.g., bridges, sidewalks, flooring, etc.), temperature, humidity, etc.

The concrete surface that has been treated using the composition of the disclosure has shown increased hardness of at least about 2, typically at least about 3, often at least about 4, and most often at least about 5 on Mohs hardness scale. Alternatively, the surface that has been treated with the composition of the disclosure requires at least about 0.10 Mpa, typically at least about 0.25 Mpa, often at least about 0.75 Mpa, and most often at least about 1.5 Mpa of pressure to produce visually observable scratches or surface damages.

Compositions of the disclosure can be used in a variety of other applications including as a concrete admixture or adjuvant to a concrete mixture. It is believed that adding a composition of the disclosure into the concrete mixture can potentially increase the workability of the concrete and increase the total amount of C—S—H as the Ca(OH)₂ has the potential to assist in the creation of C—S—H while in the plastic state. The amount of composition of the disclosure added to the concrete mixture can vary depending on a variety of factors such as, but not limited to, the hardness of concrete desired, concentration of the composition, temperature, etc. Typically, when used as adjuvant, the amount of composition of the disclosure added to 1 KG of the concrete mixture ranges from about 0.0001 L to about 0.01 L, typically from about 0.0002 L to about 0.005 L, often from about 0.0004 L to about 0.001 L. It should be appreciated, however, that the amount of composition of the disclosure added to a concrete mixture is not limited to these ranges, but can vary widely depending on the various factors. In general, however, over addition of the composition of the disclosure to the concrete mixture should be avoided. One of ordinary skill can readily determine the maximum desired amount of composition of the disclosure that can or should be added to a concrete mixture when used as an adjuvant. For example, one can add different amounts of the composition to a small sample size of the concrete mixtures and determined the physical characteristics of each concrete samples to determine the maximum amount of the composition to be used.

Compositions of the disclosure can also be used as a concrete finishing aid. As an illustrative example, applying the composition at about 500 to about 800 sq ft per gallon, one can have positive effect on the trowelling process while preparing the concrete surface for densification. Preliminary tests showed the composition of the disclosure was helpful in trowelling and resulted in the best overall appearance in slab tests. One particular application process is to spray the formulation of the disclosure on the slab and power trowel to desired finish.

Compositions of the disclosure can also be used as a solution to carbonated concrete. Carbonation of concrete occurs when calcium hydroxide in the concrete reacts with carbon dioxide in the atmosphere and creates a calcium carbonate and water. This process starts at the concrete surface and gradually moves towards the inside the concrete. When the carbonation front reaches the reinforcement bar, it could start the corrosion of steel. Carbonation of concrete can lead to increased volume around the reinforcement, thereby allowing cracks to appear in the cover zone and exposing the reinforcement to the environment. In addition, spalling could also occur due to this corrosion with the increase in the internal volume. Thus, carbonation of concrete affects the strength of the reinforcement leading to loss of its tensile strength. Compositions of the disclosure is particularly useful in treating carbonated concrete to increase its strength. Carbonation of concrete reduces the amount of C—S—H, thereby weakening the concrete. Compositions of the disclosure can be used to treat concrete that have been weakened from the carbonation process since compositions of the disclosure increase the amount of CHS.

In one particular experiment, a concrete slab having Moh's hardness of 2.5 to 3 were treated with a composition of the disclosure followed by applying a silicate densifying agent. This treatment resulted in a concrete slab having Moh's hardness's of from about 7.5 to about, thereby showing compositions and methods of the disclosure increase hardness of concrete significantly. Briefly, for this experiment, a concrete floor was first cleaned and any excess water was removed such that the concrete floor had no visible water puddles. It should be noted that it is acceptable to have moisture in the concrete pore structure. The composition of the disclosure was applied at a rate ranging from about 100 SqFt/G to 200 SqFt per gallon depending on the floor porosity. The applied composition was allowed to remain on the concrete floor surface for about 1 hour while keeping the concrete floor surface wet the entire time, e.g., by spraying with water or additional amount of composition of the disclosure as necessary. The composition on the surface of concrete is agitated in order to allow the composition of the disclosure to penetrate pores of concrete. After at least one hour, the concrete floor surface was cleaned with water and a silicate densifier was applied at a similar rate. It should be appreciated that as with application rate of the composition of the disclosure, the application rate of silicate densifier can also vary, but typical rate ranges from about 100 SqFt/G to about 200 SqFt per gallon.

Compositions of the disclosure can also be used as a solution for low carbon cement mixes. Lower carbon cement used to produce lower carbon concrete has reduced the amount of available calcium hydroxide, thereby reducing the potential for maximum CSH formation during the densification process. Adding the composition of the disclosure as a topical or surface application allowed to dwell for maximum penetration has the potential to restore and increase the CH levels in concrete to that of OPC concrete, thus allowing for more CSH to be created through the densification process.

Additional objects, advantages, and novel features of this invention will become apparent to those skilled in the art upon examination of the following examples thereof, which are not intended to be limiting. In the Examples, procedures that are constructively reduced to practice are described in the present tense, and procedures that have been carried out in the laboratory are set forth in the past tense.

### EXAMPLES

### Example 1

The following process was used to test concrete surfaces abrasion resistance listed in Table 1. Typical procedure is as follows. The concrete surface to be tested was cleaned. A composition was applied at a rate of 200 SqFt per gallon to a cleaned and wet concrete surface having no wetter than a SSD condition. The resulting concrete surface was agitated, e.g., by brushing the surface with a broom, for about 1 hour. Additional composition of the disclosure was added, if the concrete surface dried. After agitation, the resulting concrete surface was cleaned with water and excess water removed from the concrete surface. The concrete surface was again maintained at no wetter than a SSD condition.

Either a 15% sodium silicate or a 25% sodium silicate densifier solution was applied at 200 SqFt per gallon. The surface was agitated for 1 hour with addition of water if needed to avoid drying of concrete surface. The resulting treated concrete surface was cleaned with water. Surface abrasion test was conducted. The results of initial concrete surface abrasion test and treated concrete surface abrasion tests are shown in Table 1 below.

TABLE 1

| TEST SIZE | TEST TYPE | Composition (% wt/vol) | TEST RESULTS |
|---|---|---|---|
| 200 SqFt | In-situ | Water Distilled (34.50%); | Tested 4 squares 3 with the |
| | | 99.7% Glycerin (64.15%); | product 1 as a control, Moh's |
| | | and CA(OH)₂ (1.29%) | increased by 2 in 2 days and |
| | | | by 4 in 7 days |
| 200 SqFt | In-situ | Water Distilled (34.50%); | Increased Moh's from 2.5 to |
| | | 99.7% Glycerin (64.15%); | 5.5 after 5 days |
| | | and CA(OH)₂ (1.29%) | |
| 200 SqFt | In-situ | Water Distilled (34.50%); | Began by testing the floor pH, |
| | | 99.7% Glycerin (64.15%); | floor pH was 8, the product |
| | | and CA(OH)₂ (1.29%) | once applied increase the pH |
| | | | to 11, initial Moh's was 2.5, |
| | | | after 1 day the Moh's was 4.5, |
| | | | after 5 days Moh's was 6.5. I |
| | | | believe this was from |
| | | | increasing the dwell time. |
| 200 SqFt | Penetration | Water Distilled (34.50%); | Of the 4 tests penetration |
| | | 99.7% Glycerin (64.15%); | averaged 3.5 to 4.5 mm |
| | | and CA(OH)₂ (1.29%) | |
| 180,000 | in situ | Water Distilled (64.16%); | Product preformed |
| SqFt | | 99.7% Glycerin (34.55%); | exceptionally well, original |
| | | and CA(OH)₂ (1.28%) | floor was carbonated concrete |
| | | | scratching with a #3 Moh's |
| | | | pic, after 5 days the floor |
| | | | scratched with a # 7 Moh's |
| | | | pic, after 14 days the floor |
| | | | scratched with a 8 in most |
| | | | areas and a 9 in the cool |
| | | | storage area. |
| 45,000 | | Water Distilled (84.80%); | Test floor was a scratched |
| SqFt | | 70% Glycerin (14.90%); and | with a number 3 Moh's pencil |
| | | CA(OH)₂ (0.21%) | after 5-6 days the scratch was |
| | | | 7-8 and after 14 days the |
| | | | scratch was 8-9 |
| 8 × 4000 ML | Batch | Water Distilled (34.55%); | Tested for Ph and RI at 9:07, |
| batches | consistency | 99.7% Glycerin (64.16%); | meeting expected |
| | test | and CA(OH)₂ (0.90%) | specifications. At 9:10 product |
| | | | was transferred to Jug with |
| | | | minimal apparent settlement |
| | | | left in the beaker. * batch |
| | | | consistency was less than 1% |
| | | | deviation |
| 2 × 100 | Site test | Tap Water (79.40%); | Tested for Ph and RI at |
| SqFt | | 99.7% Glycerin (20.00%); | 2:00pm and transferred into a |
| | | and CA(OH)₂ (0.60%) | 1 gallon jug to be kept in the |
| | | | lab for further testing. 2 retain |
| | | | samples were taken for the |
| | | | shelf and oven. Physicals |
| | | | remain in range. Some settling |
| | | | has occurred |
| 2 × 100 | Site test | Water Distilled (79.40%); | Tested for Ph and RI at |
| SqFt | | 99.7% Glycerin (20.00%); | 2:00pm and transferred into a |
| | | and CA(OH)₂ (0.60%) | 1 gallon jug to be kept in the |
| | | | lab for further testing. 2 retain |
| | | | samples were taken for the |
| | | | shelf and oven. Physicals |
| | | | remain in range. Some settling |
| | | | has occurred |
| 4056.82 | Abrasion | Tap Water (34.55%); | Physicals are within 1% of |
| Ml | | 99.7% Glycerin (64.16%); | other batches. Test was |
| | | and CA(OH)₂ (1.28%) | conducted for Scratch and a |
| | | | Tabor abrader test against a |
| | | | control. Initial scratch and |
| | | | control sample scratch 2.5 on |
| | | | the Moh's scale, 5 day scratch |
| | | | on sample is 5.5. Second |
| | | | scratch test is 7.5. Conducted |
| | | | Taber test against control |
| | | | 82.36% less abrasion. |
| | | | Additional scratch test on |
| | | | Aug. 22, 2024 was 8.5 |

### Example 2

This example illustrates a method for using the composition of the disclosure having a relatively lower calcium hydroxide in low carbon concrete or concrete that has not undergone a significant carbonation.

Using the similar procedure as described in Example 1, a composition comprising 0.8% calcium hydroxide was used as follows:
Composition of the disclosure was applied to a concrete surface at a rate of 200 ft² per gallon.
The applied composition was agitated to maintain a wet surface for 30 minutes.
The residual material was removed using clean water.
After the concrete surface was dried (minimum 2 hours, via visual inspection), a densifier was applied.

It should be noted that the densifier should be applied once the concrete is visibly dry but no later than 24-48 hours post-application to ensure optimal results.

The results along with results of Example 3 below are shown in Table 2.

### Example 3

This example illustrates a method for using the composition of the disclosure having a relatively higher calcium hydroxide in carbonated concrete or concrete that has undergone carbonation.

Using the similar procedure as described in Example 1, a composition comprising 1.28% calcium hydroxide was used as follows:
Composition of the disclosure was applied to a concrete surface at a rate of 200 ft² per gallon.
The applied composition was agitated to maintain a wet surface for 1 hour.
The residual material was removed using clean water.
After the concrete surface was dried (minimum 2 hours, via visual inspection), a densifier was applied.

The results along with results of Example 2 below are shown in Table 2.

| | | MIXING | |
|---|---|---|---|
| TEST SIZE | MATERIALS | OBSERVATIONS | TEST RESULTS |
| 4 each 4′ × 4″ | Water Distilled | Liquids mixed easily, 20 | Tested 4 squares 3 with the |
| test squares | (34.50%); | minute mix time. | product 1 as a control, Moh's |
| | Glycerin 99.7% | | increased by 2 in 2 days and by |
| | (64.15%); | | 4 in 7 days |
| | CA(OH)₂ (1.29%) | | |
| 200 SqFt | Water Distilled | Mixed easy. 20 Minute | Increased Moh's from 2.5 to 5.5 |
| | (34.50%); Glycerin | mix time | after 5 days |
| | 99.7% (64.15%); | | |
| | CA(OH)₂ (1.29%) | | |
| 200 SqFt | Water Distilled | Mixed same as before | Began by testing the floor pH, |
| | 34.50% | | floor pH was 8, the product once |
| | Glycerin 99.7% | | applied increase the pH to 11, |
| | 64.15% | | initial Moh's was 2.5, after 1 day |
| | CA(OH)₂ | | the Moh's was 4.5, after 5 days |
| | 1.29% | | Moh's was 6.5. I believe this |
| | | | was from increasing the dwell |
| | | | time. |
| 4 ea 4″ × 4″ | Water Distilled | Mixed easily, same as | Of the 4 tests penetration |
| test squares | (34.50%); Glycerin | before. | averaged 3.5 to 4.5 mm |
| | 99.7% (64.15%); | | |
| | CA(OH)₂ (1.29%) | | |
| 180,000 | Water Distilled | Glycerin was added, | Product preformed exceptionally |
| SqFt | 64.16% | agitated, and become | well, original floor was |
| | Glycerin 99.7% | thoroughly mixed. Haze | carbonated concrete scratching |
| | 34.55% | dissipated after a few | with a #3 Moh's pic, after 5 days |
| | CA(OH)₂ | minutes of mixing. | the floor scratched with a # 7 |
| | 1.28% | Distilled Water was | Moh's pic, after 14 days the |
| | | added first to a tank. | floor scratched with a 8 in most |
| | | Utilizing a center | areas and a 9 in the cool storage |
| | | agitator. No | area. |
| | | observations to report. | |
| | | CaOH was added slowly | |
| | | into batch. | |
| | | Noted an immediate | |
| | | discoloration to a | |
| | | tan color, becoming | |
| | | consistently darker | |
| | | throughout agitation. | |
| | | Tested for Ph and RI, | |
| | | meeting expected | |
| | | specifications. Product | |
| | | was transferred to drums | |
| | | with some settlement | |
| | | left in mixing tank. | |
| 45,000 | Water Distilled | After the full amount of | Test floor was a scratched with a |
| SqFt | 84.80% | distilled water was | number 3 Moh's pencil after 5-6 |
| | Glycerin 70% | added, it barely reached | days the scratch was 7-8 and |
| | 14.90% | the center agitator. | after 14 days the scratch was 8-9 |
| | CA(OH)₂ | However, it was able to | |
| | 0.21% | mix well. Mixed well | |
| | | into batch for 20 min. | |
| | | Mixed in to parts (50%), | |
| | | Test results for both are | |
| | | listed below | |
| 8 4000 ML | Distilled Water | 34.55% Glycerin was | Tested for Ph and RI at 9:07, |
| batches | 34.55% | added at 8:19. It took | meeting expected specifications. |
| | Glycerin 99.7% | 7.5 minutes for the | At 9:10 product was transferred |
| | 64.16% | Glycerin to be added, | to Jug with minimal apparent |
| | CA(OH)₂ | agitate, and become | settlement left in the beaker. * |
| | 0.90% | thoroughly mixed. Still | batch consistency was less than |
| | | retains a slight haze | 1% deviation |
| | | from the glycerin in the | |
| | | center of the mix for an | |
| | | addition 2-3 minutes. | |
| | | 64.16% Distilled Water | |
| | | was added first to a | |
| | | 4,000 ml glass beaker at | |
| | | 8:15. Utilizing a | |
| | | magnetic mixer. No | |
| | | observations to report. | |
| | | 0.9% CaOH was added | |
| | | slowly into batch over | |
| | | the span of 4 minutes at | |
| | | 8:34 Immediate | |
| | | discoloration to a tan | |
| | | color, becoming | |
| | | consistently darker | |
| | | throughout the 15 | |
| | | minutes of agitation. | |
| | | Mixed at 7 speed on | |
| | | magnetic mixer. | |
| 2 × 100 | Tap Water | 20% Glycerin was | Tested for Ph and RI at 2:00pm |
| SqFt | 79.40% | added to the tap water in | and transferred into a 1 gallon |
| | Glycerin 99.7% | the beaker at 1:06. The | jug to be kept in the lab for |
| | 20.00% | batch mixed for 25 | further testing. 2 retain samples |
| | CA(OH)₂ | minutes. 79.4% Tap | were taken for the shelf and |
| | 0.60% | water was added at | oven. Physicals remain in range. |
| | | 1:05pm to a glass beaker | Some settling has occurred |
| | | and magnetic mixer. No | |
| | | observations. 0.6% | |
| | | CaOH was added over | |
| | | the span of 3 minutes at | |
| | | 1:35pm. Reactions | |
| | | showed Immediately, | |
| | | became cloudy, turning | |
| | | the batch to a | |
| | | nontransparent tan color. | |
| 2 × 100 | Distilled Water | 20% Glycerin was | Tested for Ph and RI at 2:00pm |
| SqFt | 79.40% | added to the tap water in | and transferred into a 1 gallon |
| | Glycerin 99.7% | the beaker at 1:06. The | jug to be kept in the lab for |
| | 20.00% | batch mixed for 25 | further testing. 2 retain samples |
| | CA(OH)₂ | minutes. 79.4% Tap | were taken for the shelf and |
| | 0.60% | water was added at | oven. Physicals remain in range. |
| | | 1:05pm to a glass beaker | Some settling has occurred |
| | | and magnetic mixer. No | |
| | | observations. 0.6% | |
| | | CaOH was added over | |
| | | the span of 3 minutes at | |
| | | 1:35pm. Reactions | |
| | | showed Immediately, | |
| | | became cloudy, turning | |
| | | the batch to a | |
| | | nontransparent tan color. | |
| 4056.82 | Tap Water | This batch pretty much | Physicals are within 1% of other |
| Ml | 34.55% | mixed as all the others | batches. Test was conducted for |
| | Glycerin 99.7% | | Scratch and a Tabor abrader test |
| | 64.16% | | against a control. Initial scratch |
| | CA(OH)₂ | | and control sample scratch 2.5 |
| | 1.28% | | on the Moh's scale, 5 day |
| | | | scratch on sample is 5.5. Second |
| | | | scratch test is 7.5. Conducted |
| | | | Taber test against control |
| | | | 82.36% less abrasion. |
| | | | Additional scratch test on |
| | | | Aug. 22, 2024 was 8.5 |
| 30,000.00 | Distilled Water | Water added first. No | Initial scratch prior to treatment |
| | 64.16% | observations. | #3 2 weeks post treatment #5 on very |
| | Glycerin 99.7% | Glycerin blended well | top surface #7 on surface just |
| | 34.55% | with water. No | below the thin limestone layer |
| | CA(OH)₂ | observations. | on top |
| | 1.28% | Batch turned milky tan | |
| | | color. Some visible | |
| | | settlement. Consistent | |
| | | with previous batches. | |
| 2,000 | Distilled Water | Water added. No | Ashford only area scratch test at |
| | 64.16% | observations. | a #6 Moh's Treated are with AF |
| | Glycerin 99.7% | Glycerin blended well | scratched with a #8 Moh's |
| | 34.55% | with water. No | |
| | CA(OH)₂ | observations. | |
| | 0.80% | Batch turned milky tan | |
| | | color. Some visible | |
| | | settlement. Consistent | |
| | | with previous batches. | |
| 175,000 | Distilled Water | Water added without | Initial scratch prior to treatment |
| | 64.16% | any observed issue. | #3. 13 days post treatment #5.5 |
| | Glycerin 99.7% | Glycerin blended till | on very top surface #7.5 on |
| | 34.55% | batch was clear and | surface just below the thin |
| | CA(OH)₂ | consistent. | limestone layer on top |
| | 1.28% | Batch turned milky tan | |
| | | color. Some visible | |
| | | settlement. Consistent | |
| | | with previous batches. | |

The foregoing discussion of the invention has been presented for purposes of illustration and description. The foregoing is not intended to limit the invention to the form or forms disclosed herein. Although the description of the invention has included description of one or more embodiments and certain variations and modifications, other variations and modifications are within the scope of the invention, e.g., as may be within the skill and knowledge of those in the art, after understanding the present disclosure. It is intended to obtain rights which include alternative embodiments to the extent permitted, including alternate, interchangeable and/or equivalent structures, functions, ranges or steps to those claimed, whether or not such alternate, interchangeable and/or equivalent structures, functions, ranges or steps are disclosed herein, and without intending to publicly dedicate any patentable subject matter. All references cited herein are incorporated by reference in their entirety.

What is claimed is:

1. A solution comprising a solvent and calcium hydroxide, wherein said solvent comprises a polyhydroxy compound and water, and wherein an amount of water in said solvent is about 80% vol/vol or less.

2. The solution according to claim 1, wherein said polyhydroxy compound comprises glycerine, a sugar alcohol, or a combination thereof.

3. The solution according to claim 1, wherein said sugar alcohol comprises sorbitol, ethylene glycol, glycerol, erythritol, threitol, arabitol, xylitol, ribitol, mannitol, galactitol, fucitol, iditol, inositol, volemitol, isomalt, maltitol, lactitol, maltotriitol, maltotetraitol, polyglycitol, or a combination thereof.

4. The solution according to claim 1, wherein a concentration of calcium hydroxide in said solution ranges from about 0.1% to about 5%.

5. The solution according to claim 2, wherein the concentration of calcium hydroxide in said solution ranges from about 0.5% to about 2%.

6. A method for treating a concrete surface, said method comprising:
applying a surface hardening composition to a concrete surface which is no wetter than surface-saturated-dry (SSD) condition to produce a first treated surface, wherein said surface hardening composition comprise:
a solution comprising calcium hydroxide and a solvent comprising a polyhydroxy compound and water; and
applying a silicate densifier to the first treated surface to produce a hardened concrete surface.

7. The method according to claim 6, wherein said surface hardening composition is applied to said concrete surface for at least about 30 min to about 120 min prior to applying said silicate densifier.

8. The method according to claim 7, wherein the excess surface hardening composition is removed from said concrete surface using water prior to said step of applying the silicate densifier.

9. The method according to claim 6 further comprising preparing the concrete surface prior to applying said surface hardening composition, wherein said step of preparing the concrete surface comprises:
cleaning the concrete surface with a concrete surface cleaner;
optionally removing free-standing water from the concrete surface; and
maintaining no wetter than a SSD condition during application of said hardening composition.

10. The method according to claim 6, wherein said surface hardening composition is applied to the concrete surface at a rate of about 100 to about 300 ft²/gallon.

11. The method according to claim 6, wherein said silicate densifier is applied at a rate of about 100 to about 300 ft²/gallon.

12. The method according to claim 6, wherein said surface hardening composition is applied to an uncured surface of concrete.

13. The method according to claim 6, wherein said surface hardening composition is applied to a cured surface of concrete.

14. The method according to claim 6, wherein said hardened concrete surface has at least about 3 Mohs scale hardness increase compared to an untreated concrete surface.

15. An abrasion resistant composition for increasing an abrasion resistance of a concrete surface, said abrasion resistant composition comprising a solution of:
from about 0.1% wt/vol to about 5% wt/vol of calcium hydroxide; and
a solvent comprising:
from at least about 10% volume/volume (v/v) to about 50% v/v of a polyhydroxy compound; and
water.

16. The composition according to claim 15, wherein the amount of calcium hydroxide in said abrasion resistant composition ranges from about 0.1% wt/vol to about 2% wt/vol.

17. A method for increasing an abrasion resistance of a concrete surface, said method comprising:
applying an abrasion resistant composition of claim 15 to a wet concrete surface having no wetter than surface-saturated-dry (SSD) condition to produce a first treated surface; and
applying a silicate densifier to the first treated surface to produce a concrete surface having an increased surface abrasion resistance.

18. The method according to claim 17 further comprising a step of preparing the concrete surface prior to applying said abrasion resistant composition to said concrete surface, wherein said concrete surface preparing step comprises:
cleaning the concrete surface with a concrete surface cleaner;
optionally removing any surfactant, excess water, or a combination thereof from the concrete surface; and
maintaining no wetter than SSD condition during application of said hardening composition.

19. The method according to claim 17, wherein said composition is applied to the concrete surface at a rate of about 100 to about 300 ft²/gallon.

20. The method according to claim 19 further comprising the steps of maintaining wet and agitated state of the first treated surface prior to said step of applying the silicate densifier.
